(19) United States
(12) Patent Application Publication
(10) Pub. No.: US 2019/0073882 A1
(43) Pub. Date: Mar. 7, 2019

(54) Systems and Methods of Detecting the Disturbing Trajectories of the Movement of Objects

(71) Applicant: OOO ITV Group, Moscow (RU)

(72) Inventors: Murat K. Altuev, Chernogolovka (RU); Igor I. Falomkin, Moscow (RU); Egor P. Suchkov, Tuapse (RU); Timur V. Markin, Moscow (RU)

(21) Appl. No.: 16/043,201

(22) Filed: Jul. 24, 2018

(30) Foreign Application Priority Data
Sep. 4, 2017 (RU) 2017131075

(51) Int. Cl. G08B 13/196; H04N 7/18; G08B 7/06

(52) U.S. Cl. CPC G08B 13/19608; G08B 7/06; H04N 7/181

(57) ABSTRACT

A system for detecting alarming object trajectories involving a sensor, using object metadata, the metadata representing a set of object coordinates and locations in certain times, with a memory, at least one processor, and a user interface for performance of classification. Analyzing the metadata by the sensor and the user interface containing means of input and output of data and a rule-setting unit by which the computer system sets rules of definition of what trajectories of movements of objects are alarming. A classification of trajectories of the movement of objects with the ability to check of each trajectory of the movement and send a notification to a user in case the trajectory of the movement was alarming within a given time frame.

### RELATED APPLICATIONS

This application claims priority to Russian Patent Application No. RU 2017131075, filed Sep. 4, 2017, which is incorporated herein by reference in its entirety.

### FIELD OF THE INVENTION

The group of inventions refers to the field of video surveillance, namely to the technologies directed to detect the alarming trajectories of the movement of objects.

Let's assume that there are a map and trajectories of objects on it, for example, from GPS sensors of cars. The operator will receive an event or alarm if any car went along the forbidden route or drove to the forbidden area.

The event is also understood as existence of these or those objects, motionless or moving, their arrangement, trajectories of their movement and many other signs. The person, an animal, the vehicle, for example, the car, and any objects moving in sight of the video camera can be an object.

The also operator can be interested in alarming events, and, in particular, trajectories of the movement of objects which by any criteria became more interesting, than the others. For example, the trajectory of the movement of some object during the set time changed the direction and became alarming. In an example with cars, trajectories which long are in the territory of the enterprise can be interesting, sometimes it can speak about potential theft.

The invention can find application in various systems of video surveillance, video analytics, for example, in security systems, systems of video surveillance behind operation of the equipment, analytical systems for market researches, in the situational centers, systems of automation of production and in many other areas.

### BACKGROUND

For optimization of process of detection of alarming trajectories of the movement of objects, there are various technologies, for example, a task of some rules of classification of trajectories of the movement of objects, regarding reference of the last to alarming.

In level technicians are revealed technologies of tracking of an object, it, for example, as the vehicle in which analyze the video data received from the camera (US 2011/0170744 A1, published on Jul. 14, 2011). A lack of these technologies is the impossibility of detection of alarming trajectories of the movement of objects.

In level technicians are revealed technologies of classification of trajectories of the movement of objects for various purposes, for example, for prevention of collisions (US 2011/0255747 A1, published on Oct. 20, 2011). Shortcomings of these technologies are the impossibility of a task of rules for definition of alarming trajectories of the movement of objects.

The closest analog for the declared invention, is the technology of video surveillance in which as one of rules of detection of alarming trajectories of the movement, definition of crossing of an object and “extension” (WO 2005/050971 A2, published on Jun. 2, 2005). This technology though allows to set some rules of detection of alarming trajectories of the movement of objects, however does not allow to carry out classification of trajectories by the set rules, and also is not intended for the notification of the user about existence of an alarming trajectory of the movement of an object.

Task of the declared invention is elimination of, at least, one of shortcomings of the previous equipment level.

### BRIEF SUMMARY

Technical result of the declared group of inventions is expansion of an arsenal of technical means, regarding detection of alarming trajectories of the movement of objects, due to check regarding uneasiness of each trajectory of the movement of objects by the set rules of detection of alarming trajectories.

The yielded technical result is achieved at the expense of the system of detection of alarming trajectories of the movement of objects offered and realized by the computer containing: the sensor executed with a possibility of providing object metadata, at the same time metadata represent a set of object coordinates and their locations in certain time points; and the computer system including memory, at least, one processor and the user interface for performance of classification, collecting and processing of metadata of the objects provided by the sensor, the user interface containing means of input and output of data where the means of input contain the rule-setting unit by which the computer system sets rules of definition of what trajectories of the movement of objects are alarming, the object trajectory classification unit executed with a possibility of check of each trajectory of the movement on set in the rule-setting unit, to rules for the purpose of detection of alarming trajectories of the movement of objects, the object trajectory classification unit which is also executed with a possibility of sending the notification to the user in case the trajectory of the movement appeared or became alarming with a current of the set time.

The yielded technical result is also achieved at the expense of the computer realized device of detection of alarming trajectories of the movement of objects containing: the sensor executed with a possibility of providing object metadata, at the same time metadata represent a set of object coordinates and their locations in certain time points; and the device of detection of alarming trajectories of movements of objects contains the graphic user interface, the specified device adapts for performance of classification, collecting and processing of metadata of the objects provided by the sensor, the user interface containing means of input and output of data where the means of input contain the rule-setting unit executed with a possibility of a task of rules of definition of what trajectories of the movement of objects are alarming, the object trajectory classification unit executed with a possibility of check of each trajectory of the movement on set in the rule-setting unit, to rules, for the purpose of detection of alarming trajectories of the movement of objects, the object trajectory classification unit also executed with a possibility of sending the notification to the user in case a trajectory of the movement appeared or became alarming with a current of the set time.

The yielded technical result is also achieved at the expense of a way for realization of the system of detection of alarming trajectories of the movement of objects, containing stages, on which: provide object metadata by the sensor, at the same time metadata represent a set of object coordinates and their locations in certain time points; carry out classification, collecting and processing of metadata of the objects provided by the sensor by the computer system including memory, at least, one processor and the user interface; set rules of definition of what trajectories of the movement of objects are alarming, by the rule-setting unit of the user interface, carry out check of each trajectory of the movement on set in the rule-setting unit, to rules, by the object trajectory classification unit, for the purpose of detection of alarming trajectories of the movement of objects, carry out sending the notification to the user in case the trajectory of the movement appeared or became alarming with a current of the set time, by the object trajectory classification unit.

In one particular version of the declared decision, providing object metadata, classification performance, collecting and processing of object metadata, are also carried out by the video camera and/or by computer system and/or these stages can be divided between the video camera and computer system.

In other particular version of the declared decision, as rules of definition of what trajectories of the movement of objects are alarming, the following is defined:

the fact of existence of crossing of a trajectory of the movement of an object and some surface in space of object coordinates,

the fact of hit of a trajectory of, at least, one object to some area in space of object coordinates,

the fact of escape of a trajectory of, at least, one object of some area in space of object coordinates,

the fact of emergence of a trajectory of, at least, one object in some area in space of object coordinates,

the fact of disappearance of a trajectory of, at least, one object in some area in space of object coordinates,

the fact of a start of motion of, at least, one object in some area in space of object coordinates,

the fact of a stop of, at least, one object in some area in space of object coordinates,

determination of temporary duration of finding of a trajectory of the movement of, at least, one object in some area in space of object coordinates,

the fact of simultaneous stay in some area of several objects.

In one particular option, the graphic interface is adapted for display of object coordinates, at least, on the image, a picture, the district map received from the sensor.

In particular version of the declared decision, the surface which crosses a trajectory of the movement of an object is virtual and is, at least, one of the following: curved surface, multi-segment surface or several parallel surfaces.

In one particular option if coordinates of an object are presented in the form of two-dimensional coordinates, then the surface will be the curved line, the multi-segment line, and several parallel lines.

In other particular option, at a task of the rules characterizing, at least:

the fact of existence of crossing of a trajectory of the movement of an object and some surface in space of object coordinates,

the fact of hit of a trajectory of, at least, one object to some area in space of object coordinates,

the fact of escape of a trajectory of, at least, one object of some area in space of object coordinates,

the fact of emergence of a trajectory of, at least, one object in some area in space of object coordinates,

the fact of disappearance of a trajectory of, at least, one object in some area in space of object coordinates,

the fact of a start of motion of, at least, one object in some area in space of object coordinates,

the fact of a stop of, at least, one object in some area in space of object coordinates,

determination of temporary duration of finding of a trajectory of the movement of, at least, one object in some area in space of object coordinates,

the fact of simultaneous stay in some area of several objects, the rule-setting unit considers, at least, the following parameters of an object: direction of the movement, type, speed, size.

In one particular option, the rules of definition of what trajectories of the movement of objects are alarming, depend also on type of the sensor which provides metadata.

In other particular option, the sensor is the detector of objects in which color of an object is considered.

In other particular option, the sensor is the bracelet of security system providing GPS or GLONASS of coordinate, at the same time this device reports the identifier of the owner of a bracelet, and depending on type of this identifier, define whether to notify on alarm.

In one particular option, the sensor is the device onboard the vehicle with the sensor providing GPS or GLONASS of coordinate, at the same time this device reports the identifier of the owner of the sensor, and depending on type of this identifier, define whether to notify on alarm.

In one particular option, as additional characteristics of an object the following can be set, at least: object floor, presence at an object: bags, umbrella, headdress, moustaches, and beard.

In other particular option, the notification of the user can be, at least, visual, sound, text.

The yielded technical result is also achieved at the expense of the carrier which is read out by the computer containing the instructions which are carried out by the computer processor for implementation of above-mentioned ways of detection of alarming trajectories of the movement of objects.

### DETAILED DESCRIPTION

Below the description of approximate versions of the declared group of inventions will be provided. However, the declared group of inventions is not limited only to these options of implementation. It will be obvious to experts that under the volume of the declared group of inventions described in a claim also other options can get.

The group of inventions characterizes the system realized by the computer, the device, a way for detection of alarming trajectories of the movement of objects and the carrier which is read out by the computer containing the teams inducing the processor of the computer to carry out stages of ways for detection of alarming trajectories of the movement of objects.

In this context, the systems realized by the computer are understood as any computing systems constructed on the basis of software and hardware.

Also, the computer realized devices are understood as any computers constructed on the basis of software and hardware. Any electronic computers, for example, such as can be understood as such devices: personal computers, smart phones, laptops, tablets, video cameras, etc.

The declared ways can be also realized by any electronic computers which have technical capabilities for realization of stages of these ways.

And also, in the context of this description, sensors are understood as any computers which can provide metadata of some objects. Such devices are understood as such sensors as video cameras, various detectors of objects, GPS and GLONASS sensors and many others.

Understand the set representing, at least, object coordinates and their situation in certain time points as object metadata. Time points can be set in systems of video surveillance randomly, for example, programmatically.

The system of detection of alarming trajectories of the movement of objects (system 1) is understood as any system having, it is less to measure, the sensor, computer system, the user interface, the object trajectory classification unit, and also any other technicians of the device, famous in this level, can enter such system.

Let's give an example of work of system 1.

Work of system 1 begins with receiving a temporary number of locations of some objects by the sensor. This time row characterizes a set of object coordinates and their locations in certain time points, we will designate this set briefly—object metadata. Metadata can be presented in the form of two-dimensional or three-dimensional coordinates.

In case of representation of coordinates of an object in a two-dimensional look, the surface which can cross an object is the line.

In case of representation of coordinates of an object in a three-dimensional look, the surface which can cross an object is, at least, a curved surface, a multi-segment surface or several parallel surfaces. The specified surfaces can also be virtual.

Further, in system 1 stages of classification, collecting, processing of the received metadata is carried out. These stages can be carried out as the computer system which is a part of system 1 and by the video camera and/or stages can be divided between computer system and the video camera. Such division can be made by the operator at control of system.

The operator has an opportunity to operate system 1 by standard means of the user interface. Including, by the unit of tasks of rules (unit 1) in system 1 there is a possibility of a task of rules of definition of what trajectories of the movement of objects are alarming.

The unit 1 sets rules, proceeding from the following facts: the fact of existence of crossing of a trajectory of the movement of an object and some surface in space of object coordinates,

the fact of hit of a trajectory of, at least, one object to some area in space of object coordinates,

the fact of escape of a trajectory of, at least, one object of some area in space of object coordinates,

the fact of emergence of a trajectory of, at least, one object in some area in space of object coordinates,

the fact of disappearance of a trajectory of, at least, one object in some area in space of object coordinates,

the fact of a start of motion of, at least, one object in some area in space of object coordinates,

the fact of a stop of, at least, one object in some area in space of object coordinates,

determination of temporary duration of finding of a trajectory of the movement of, at least, one object in some area in space of object coordinates,

the fact of simultaneous stay in some area of several objects.

When determining of the specified facts, for an object the following parameters are considered, at least: the direction of the movement, object type, speed of the movement of an object, the object size, in case of definition of the fact that an object is a person are considered also: a sex, age, presence at an object of the certain distinctive features, for example, connected with features of appearance: moustaches, beard, headdress, umbrella, bag, etc.

These facts can be present at system 1 in various combinations.

Alternatively, tasks of rules, in system 1 are variants of the task of rules, depending on type of the sensor which provided object metadata.

For example, in case the sensor is the detector of objects, it is necessary to consider also color of objects.

In case the sensor is the bracelet of security system providing GPS or GLONASS of coordinate of an object, this device reports to system 1 identifier of the owner of a bracelet. On this identifier, define whether to notify on alarm or not.

Besides, in the unit 1 other rules which are not limited to these examples can be set.

Further, when rules in system 1 are set, start classification of trajectories of the movement of objects by the object trajectory classification unit (unit 2). The unit 2 checks each trajectory of the movement of objects by rules set in the unit 1.

Functions of check in the unit 2 can be adjusted depending on the concrete fact and/or at once several facts which can speak about presence of alarming signs at this or that trajectory of the movement of an object.

The unit 2 is also executed with a possibility of sending the notification to the user in case the trajectory of the movement appeared or became alarming with a current of the set time. Such notices can be, at least, visual, sound, text. The user and/or the operator in system 1 can set time and the type of the notification accepted for it. For example, if the trajectory of a certain object became alarming 10 minutes eventually, to the user the notification not less than in 5 minutes will come about it from the moment of definition of the fact of a alarming trajectory. It is also possible to set notification time equal to the fact of detection of an alarming trajectory. The notification can be in the form of the SMS or MMS to the operator and/or the user of system 1 with the indication of concrete metadata and/or parameters of an object.

Let's give examples of setting up rules of detection of alarming trajectories by the unit 1.

At setting up rules of detection of trajectories of objects in the unit 1 the following facts can be set, at least: the fact of existence of crossing of a trajectory of the movement of an object and some surface in space of object coordinates (fact 1),

the fact of hit of a trajectory of, at least, one object to some area in space of object coordinates (fact 2),

the fact of escape of a trajectory of, at least, one object of some area in space of object coordinates (fact 3),

the fact of emergence of a trajectory of, at least, one object in some area in space of object coordinates (fact 4),

the fact of disappearance of a trajectory of, at least, one object in some area in space of object coordinates (fact 5),

the fact of a start of motion of, at least, one object in some area in space of object coordinates (fact 6),

the fact of a stop of, at least, one object in some area in space of object coordinates (fact 7),

determination of temporary duration of finding of a trajectory of the movement of, at least, one object in some area in space of object coordinates (fact 8),

the fact of simultaneous stay in some area of several objects (fact 9).

At the same time the possibility of tracking of the facts 1-9 on time, and also assignment to alarming trajectories of degree of uneasiness is provided in system 1: high, average, low, false.

For example, if for an object, being the person the fact 1 is found, i.e. the trajectory of its movement crossed the surface of the carriageway, this situation can be potentially dangerous. However, at its tracking within, for example, 1 minute, it will be visible that the person successfully passed the carriageway, left it and crossed area of the sidewalk. That is this trajectory stopped being alarming after some time. If it is recognized as system 1 as alarming, it can be regarded as false operation.

Let's give some more examples in table 1.

TABLE 1

| Parameters object | 1 | | 2 | | 3 | | 4 | | 5 | |
|---|---|---|---|---|---|---|---|---|---|---|
| Object type | person | | car | | child | | bag | | two persons | |
| Direction of | Entered into | | Disappeared | | Entered into | | Movement on | | Movement on | |
| the movement | shop, left shop | | from the | | school | | the conveyor | | the park | |
| | | | parking | | | | with baggage | | | |
| Speed of the | 1 | km/h | 120 | km/h | 3 | km/h | 0.3 | m/s | 4 | km/h |
| movement | | | | | | | | | | |
| Size | 1.70 | m | Class B car | | 1.20 | m | 45 × 25 × 56 cm | | 1.65 m, | |
| | | | | | | | | | 1.75 m | |
| Distinctive | Hat, beard | | Registration | | Baseball cap, | | Red tape | | Ladies' bag, | |
| signs | | | plates are | | backpack | | | | umbrella | |
| | | | hidden | | | | | | | |
| Existence of | 2.5 | | 5 | | 1.6 | | 1.3 | | — | |
| the facts from | | | | | | | | | | |
| 1 to 9 | | | | | | | | | | |
| Time of | 5 | min. | 60 | min. | 20 | min. | 3 | min. | 7 | min. |
| tracking of an | | | | | | | | | | |
| object | | | | | | | | | | |

| | | | | | |
|---|---|---|---|---|---|
| Alarm degree | average | high | low | high | — |
| The | + | + | + | + | — |
| notification | | | | | |
| about alarm | | | | | |

For example, in a case with the child (object 3), an entrance to school is not dangerous, however, the notification about the fact of an entrance can come to the user, for example, to the parent. This fact will be useful in case of further tracking of a trajectory of the movement of the child, and establishment, for example, of the fact of escape of the child of the schoolhouse. For example, escape of school can be regarded as an alarming event ahead of time. Or change of a trajectory of the movement of the child and the fact of crossing of the carriageway in not put place is also regarded as a alarming event.

In case of a situation with an object 5, alarming events or trajectories it is not revealed, means and notifications are not necessary. Objects, i.e. people in this case just walk in the park. At further tracking, and at emergence of some alarming facts, the corresponding notifications about such facts can be sent.

Let's give an example of a task of the rule of the definition of a alarming trajectory the unit 1 connected with the fact of detection of crossing of a trajectory of an object and a virtual curved surface.

For example, in system 1 there is a tracking of a trajectory of the movement of the car.

The set of curved surfaces which follow on a contour of one or several areas in a scene can cross a trajectory of the movement of the car on the course of its change. These surfaces can also be multi-segment, i.e. consisting more than of one linear segment. Besides, in system 1 the rules characterizing multiple parallel surfaces can be set. And also, such rules in which the trajectory of the movement of an object would cross all surfaces in a certain order or during the certain period of time can be set.

Both other options and the invention can be possible it is not limited to these examples.

Let's give an example of functioning of a way which stages realize system 1.

Stage 1: Providing object metadata by the sensor, the sensor can be, at least, the video camera, the detector of objects, the GPS and/or GLONASS sensor, a bracelet of the security alarm system, etc.

Stage 2: Performance of classification, collecting and processing of object metadata which are provided by the sensor, by computer system.

Stage 3: The task of rules of definition of what trajectories of the movement of objects are alarming by the unit 1.

Stage 4: Check each trajectory of the movement on 1 rules set in the unit for the purpose of detection of alarming trajectories. Check is carried out in the unit 2.

Stage 5: Send notifications to the user in case the trajectory of the movement appeared or became alarming with a current of the set time, by the unit 2.

Options of implementation of the real group of inventions can be realized with use of the software, hardware, program logic or their combination. The program logic, the software or a set of instructions are stored in an example of implementation on one of various traditional machine-readable carriers. In the context of this document any environment or means which may contain, to store, transfer, extend or transport instructions for their use by system of implementation of instructions, the equipment or the device, such as computer can be “the machine-readable carrier”. The machine-readable carrier can turn on the non-volatile machine-readable carrier of data which can be any environment or the means containing or storing instructions for their use by system of implementation of instructions, the equipment or the device such as computer, or for use in connection with them.

In one of examples of implementation the scheme, or the scheme of the user interface configured for ensuring, at least, some functions of management described above can be offered.

If it is necessary, at least, a part of various functions considered in this description can be executed in excellent from presented an order and/or at the same time with each other. Besides, if necessary one or more of the functions described above can be optional or can be combined.

Though in independent points of a formula of the invention various aspects of the present invention are characterized, other aspects of the invention include other combinations of signs from the described options of implementation and/or dependent points of a formula of the invention together with signs of independent points of a formula of the invention, at the same time the combinations are not necessarily obviously specified in the claims of the invention.

1. A system for detecting alarming object trajectories, comprising:
a sensor providing object metadata, the metadata representing a set of object coordinates and object locations at certain times;
a computer system for classification, collecting, and processing of the metadata of the objects provided by the sensor comprising a memory, at least one processor, and a user interface;
the user interface comprising a data input device and a data output device, wherein the data input device comprises a rule-setting unit, whereby the computer system sets rules defining alarming object trajectories; and
an object trajectory classification unit checking object trajectories against the rules set in the rule-setting unit for detecting alarming objects trajectories;
wherein the object trajectory classification unit sends a notification to a user when a trajectory is alarming.

2. The system of claim 1, wherein providing object metadata, classification, collection, and processing of object metadata, is performed by a video camera or by the computer system or by the video camera and the computer system.

3. The system of claim 1, wherein the rules comprise:
existence of intersection of an object trajectory and a surface;
at least one object trajectory enters an area;
at least one object trajectory exits an area;
at least one object trajectory is within an area;
at least one object trajectory disappeared within an area;
at least one object starts moving within an area;
at least one object stops within an area;
duration of at least one object trajectory within an area; or
simultaneous presence of several objects within an area.

4. The system of claim 3, wherein the surface intersecting the object trajectory is virtual and is at least one of the following: a curved surface, a multi-segment surface, or several parallel surfaces.

5. The system of claim 1, wherein the graphical interface displays the object coordinates on an image, a picture, or a terrain map received from the sensor.

6. The system of claim 1, wherein the object coordinates are two-dimensional coordinates.

7. The system of claim 1, wherein the rules set by the rule setting unit depend on one of the following parameters of an object: direction of the movement, type, speed, or size.

8. The system of claim 1, wherein the rules depend on a type of the sensor.

9. The system of claim 1, wherein the sensor detects object color.

10. The system of claim 1, wherein the sensor is a security system bracelet providing GPS or GLONASS coordinates, reporting an identifier of a bracelet holder, and, depending on a type of the identifier, defines whether to send an alarm notification.

11. The system of claim 1, wherein the rules depend on:
object gender, or
whether an object has a bag, an umbrella, a hat, a moustache, or a beard.

12. The system of claim 1, wherein the notification is visual, sound, or text.

13. A device for detecting alarming object trajectories, comprising:
a sensor providing object metadata, the metadata representing a set of object coordinates and object locations at certain times;
a computer system for classification, collecting, and processing of the metadata of the objects provided by the sensor comprising a user interface;
the user interface comprising a data input device and a data output device, wherein the data input device comprises a rule-setting unit setting rules defining alarming object trajectories; and
an object trajectory classification unit checking object trajectories against the rules set in the rule-setting unit for detecting alarming objects trajectories;
wherein the object trajectory classification unit sends a notification to a user when a trajectory is alarming.

14. The device of claim 13, wherein providing object metadata, classification, collection, and processing of object metadata, is performed by a video camera or by the computer system or by the video camera and the computer system.

15. The device of claim 13, wherein the rules comprise:
existence of intersection of an object trajectory and a surface;
at least one object trajectory enters an area;
at least one object trajectory exits an area;
at least one object trajectory is within an area;
at least one object trajectory disappeared within an area;
at least one object starts moving within an area;
at least one object stops within an area;
duration of at least one object trajectory within an area; or
simultaneous presence of several objects within an area.

16. The device of claim 15, wherein the surface intersecting the object trajectory is virtual and is at least one of the following: a curved surface, a multi-segment surface, or several parallel surfaces.

17. The device of claim 13, wherein the graphical interface displays the object coordinates on an image, a picture, or a terrain map received from the sensor.

18. The device of claim 13, wherein the object coordinates are two-dimensional coordinates.

19. The device of claim 13, wherein the rules set by the rule setting unit depend on one of the following parameters of an object: direction of the movement, type, speed, or size.

20. The device of claim 13, wherein the rules depend on a type of the sensor.

21. The device of claim 13, wherein the sensor detects object color.

22. The device of claim 13, wherein the sensor is a security system bracelet providing GPS or GLONASS coordinates, reporting an identifier of a bracelet holder, and, depending on a type of the identifier, defines whether to send an alarm notification.

23. The device of claim 13, wherein the rules depend on:
object gender, or
whether an object has a bag, an umbrella, a hat, a moustache, or a beard.

24. The device of claim 13, wherein the notification is visual, sound, or text.

25. A method for detecting alarming object trajectories, comprising:
providing by a sensor object metadata, the metadata representing a set of object coordinates and object locations at certain times;
perform, by a computer system comprising a memory, at least one processor, and a user interface, classification, collecting, and processing of the metadata of the objects provided by the sensor;
setting rules defining alarming object trajectories by a rule-setting unit of the user interface;
detecting alarming objects trajectories by an object trajectory classification unit by checking object trajectories against the rules set in the rule-setting unit for; and
sending by the object trajectory classification unit a notification to a user when a trajectory is alarming.

26. The method of claim 25, wherein the providing object metadata, classification, collection, and processing of object metadata, is performed by a video camera or by the computer system or by the video camera and the computer system.

27. The method of claim 25, wherein the rules comprise:
existence of intersection of an object trajectory and a surface;
at least one object trajectory enters an area;
at least one object trajectory exits an area;
at least one object trajectory is within an area;
at least one object trajectory disappeared within an area;
at least one object starts moving within an area;
at least one object stops within an area;
duration of at least one object trajectory within an area; or
simultaneous presence of several objects within an area.

28. The method of claim 27, wherein the surface intersecting the object trajectory is virtual and is at least one of the following: a curved surface, a multi-segment surface, or several parallel surfaces.

29. The method of claim 25, wherein the graphical interface displays the object coordinates on an image, a picture, or a terrain map received from the sensor.

30. The method of claim 25, wherein the object coordinates are two-dimensional coordinates.

31. The method of claim 25, wherein the rules set by the rule setting unit depend on one of the following parameters of an object: direction of the movement, type, speed, or size.

32. The method of claim 25, wherein the rules depend on a type of the sensor.

33. The method of claim 25, wherein the sensor detects object color.

34. The method of claim 25, wherein the sensor is a security system bracelet providing GPS or GLONASS coordinates, reporting an identifier of a bracelet holder, and, depending on a type of the identifier, defines whether to send an alarm notification.

35. The method of claim 25, wherein the rules depend on:
object gender, or
whether an object has a bag, an umbrella, a hat, a moustache, or a beard.

36. The method of claim 25, wherein the notification is visual, sound, or text.

37. A non-transitory computer-readable medium with executable program stored thereon, wherein the program comprises instructions for a computer processor for implementation of the method of claim 25.
